(19) United States
(12) Patent Application Publication
(10) Pub. No.: US 2003/0056665 A1
(43) Pub. Date: Mar. 27, 2003

(54) Printing screen

(76) Inventor: Toru Tanaka, Kanagawa (JP)

Correspondence Address: SONNENSCHEIN NATH & ROSENTHAL, P.O. BOX 061080, WACKER DRIVE STATION, CHICAGO, IL, 60606-1080, US

(21) Appl. No.: 09/572,773

(22) Filed: May 17, 2000

(30) Foreign Application Priority Data
May 20, 1999 (JP) P11-140443

(51) Int. Cl. B41L 13/00

(52) U.S. Cl. 101/127.1

(57) ABSTRACT

A printing screen transferring a printing material to a printed surface of a printing object which is capable of suppressing printing defects due to distortion of the screen occurring when pulling the printed surface and the screen apart from each other and which is capable of printing a predetermined pattern of the printing material with a high precision, including a sheet-like screen provided with a mask formed with a predetermined pattern of openings in which a printing material is to be filled, a frame arranged away from the outside of the screen, and a support which connects the frame and the screen and supports the screen moveably with respect to the frame and printing the printing material supplied to one surface of the screen on to the printed surface of the printing object contacting the other surface through a mask, wherein contour shapes of connection portions of the screen and the frame to which the support is connected are circular.

### BACKGROUND OF THE INVENTION

1. Field of the Invention

The present invention relates to a printing screen suitable for formation of for example a bump to an electrode pad of an IC chip formed on a semiconductor wafer or an electrode formed on a printed circuit board, a fine pattern on a board, etc. by screen printing using a solder paste or other material.

2. Description of the Related Art

Along with advances in increasing the density of mounting of electronic components on a board, reduction of the size of semiconductor packages has been demanded. As the method of mounting a small semiconductor package onto a board, the so-called “flip-chip” mounting method of forming bumps on the electrode pads of a semiconductor chip and electrically and physically connecting these bumps with electrode terminals of the mounting board is now attracting attention.

The method of formation of bumps on the electrode pads of a semiconductor chip includes the method of forming the bumps all together in the state where the IC chips are still as formed on the semiconductor wafer and the method of first cutting the semiconductor wafer into the individual IC chips and the forming the bumps for every IC chip. The method of forming the bumps all together on the electrode pads of the IC chips in the state where the IC chips are still as formed on the semiconductor wafer is preferred from the viewpoint of the manufacturing costs.

As one of the methods of forming bumps all together on electrode pads of the IC chips in the state where the IC chips are still as formed on the semiconductor wafer, for example, there is known the screen printing method of using a solder paste and a printing screen having a mask formed with a predetermined pattern of openings to transfer solder onto the electrodes of the IC chips and thereby form solder bumps on the electrodes of the IC chips.

In the screen printing method, high precision printing requires use of a screen made of for example a metal resistant to sag in the screen plane, elongation, or other distortion from the viewpoint of raising the dimensional precision of the screen. Further, it requires the use of so-called “contact printing”, that is, bringing the screen into tight contact with the substrate, from the viewpoint of reducing the so-called “bleeding”, that is, the entry of the solder paste used as the printing material into a gap between the screen and the substrate.

FIG. 1 is a plan view of an example of the structure of a printing screen, and FIG. 2 is a sectional view taken along a line D-D of the printing screen shown in FIG. 1.

In FIG. 1 and FIG. 2, a printing screen 101 has a screen 102, a rectangular frame 106 arranged spaced apart from the outside of the screen 102, and a mesh screen 104, connecting the screen 102 and the frame 106, made for example of a mesh of a metal fiber or a synthetic resin fiber.

The screen 102 has a mask 102a which is made of a rectangular metal sheet and is formed with a predetermined pattern of openings at the center.

The mesh screen 104 has a rectangular outer shape roughly corresponding to the shape of the frame 106 and has a rectangular opening 104a roughly corresponding to the outer shape of the screen 102. The outer periphery of one surface is bonded to an end face of the frame 106 by an adhesive 107, while the inner periphery of the other surface is bonded to one surface of the screen 102 by an adhesive 108. The mesh screen 104 has elasticity with respect to the force acting in its plane and supports the screen 102 in a state giving tension to the screen 102.

Next, an explanation will be given of a printing method using the printing screen 101 having the above structure for printing for example a solder paste on a substrate.

First, as shown in FIG. 3, a printed surface 130a of the substrate 130 and the bottom surface of the screen 102 are brought into face contact and a solder paste 140 is supplied to the top surface of the screen 102.

From this state, the front end of a squeegee 150 made of a plate-like rubber member having elasticity is brought into contact with the top surface of the screen 102 and made to move in the arrow direction while pressing the solder paste 140 obliquely downward.

By this, the solder paste 140 is rolled at the front surface of the squeeze 150 and fills the openings constituting the mask 102a of the screen 102.

Next, as shown in FIG. 4, the screen 102 is pulled away from the substrate 130.

When the printing screen 101 is pulled away from the substrate 130 in the direction indicated by the arrow, the solder paste 140 filled in the openings of the mask 102a of the screen 102 is transferred to the printed surface 130a of the substrate 130 to form a projecting solder paste pattern 141 for example.

In the above printing screen 101, the screen 102 made of the metal sheet is supported by the mesh screen 104 having elasticity and is given tension by the mesh screen 104, therefore is resistant to sag, elongation, and other distortion. Due to this, the screen 102 and the substrate 130 can be placed into close contact with each other. Further, since tension is given to the screen 102 by the mesh screen 104, the flatness and a dimensional precision of the screen 102 are high.

For this reason, when pulling the screen 102 and the printed surface 130a of the substrate 130 apart from each other after printing the solder paste 140 through the screen 102, there are little printing defects and high precision printing becomes possible.

A printing screen 101 having the above configuration, however, suffers from the following disadvantages.

For example, as explained above, after squeezing the solder paste 140 on to the substrate 130 by the squeegee 150 as shown in FIG. 5, the printing screen 101 is pulled away from the substrate 130 as shown in FIG. 6. At this time, however, since the shape of the screen 102 is rectangular, the tension given from the mesh screen 104 to the screen 102 does not become uniform.

As shown in FIG. 6, when comparing a point Pa at the corner of the screen 102 and a point Pb on an edge of the screen 102, the tension from the screen 102 acting upon the point Pa becomes larger than that of the point Pb. Namely, a tension larger than that for other areas acts upon the corners of the screen 102.

When pulling away the printing screen 101 from the substrate 130, the four corners of the screen 102 first start to separate, then the screen 102 gradually separates from the outside to the inside of the screen 102.

If the four corners of the screen 102 first start to separate, for example, a large distortion as shown in FIG. 7 occurs in the screen 102 and the flatness of the screen 102 is lost.

Due to this local distortion near the corners, forces in directions other than the direction perpendicular to the substrate 130 act upon the solder paste 140 filled in the openings of the mask 102a of the screen 102. Part of the solder paste 140 is removed while still held in the openings of the mask 102a of the screen 102, therefore the amount of the solder paste 140 left on the substrate 130 becomes smaller, the shape of the solder paste pattern 141 transferred to the substrate 130 deforms and adjoining parts of the solder past pattern 141 come into contact, and other disadvantages occur.

The above disadvantages become a major problem when forming a fine pattern of a pitch between electrodes of less than about 300 μm or projecting electrode bumps by a solder paste pattern 141 by the screen printing method.

### SUMMARY OF THE INVENTION

An object of the present invention is to provide a printing screen, for supplying a printing material onto a screen to transfer a predetermined pattern of the printing material to the printed surface of the object being printed through a mask formed on the screen, capable of suppressing printing defects due to distortion of the screen occurring when pulling the printed surface and the screen apart from each other, and therefore capable of printing the predetermined pattern of the printing material with a high precision.

According to the present invention, there is provided a printing screen comprising a screen provided with a mask formed with a predetermined pattern of openings into which a printing material is to be filled, a frame arranged away from the outside of the screen, and a support which connects the frame and the screen and supports the screen moveably with respect to the frame, wherein a contour of a connection portion of the screen to which the support is connected is formed as a curve.

Preferably, the printing screen, wherein a contour of a connection portion of the frame to which the support is connected is formed as a curve.

Preferably, the contour of the connection portion of said screen comprises a circle.

The contour of the connection portion of the frame comprises a circle.

More preferably, the contours of the connection portion of the screen and the connection portion of the frame are concentric circles.

The support supports the screen in a state imparting tension to the screen.

The screen is made of a metal material.

The support is a sheet of a mesh of fibers.

The frame is a ring member having at least one end face and the support is bonded to the end face.

The support and the screen are bonded to each other's surfaces.

Preferably, the fiber is made of a metal material.

Alternatively, the fiber is made of a synthetic resin.

Preferably, the predetermined pattern of a mask is a pattern for forming a bump on an electrode of an IC chip formed on a semiconductor wafer.

Alternatively, the predetermined pattern of a mask is a pattern for forming a bump on an electrode formed on printed circuit board for mounting an electronic device.

One surface of the screen is supplied with the printing material to be transferred to the object being printed and is brought into contact with a moving squeegee.

The frame has a shape enabling mounting to a predetermined mounting portion of a printing machine.

The printing screen further has an mounting frame mountable to a predetermined mounting portion of a printing machine.

Preferably, the frame is a ring-shaped member, the mounting frame is arranged away from the outside of the frame, and the frame and the mounting frame are connected by a support member.

The support member is arranged at substantially equal intervals along the outer periphery of the frame.

Preferably, the mounting frame is a rectangular member.

Preferably, the printing material is a solder paste.

The support has elasticity with respect to force acting in the plane of the support.

In the present invention, after bringing the screen into contact with the printed surface and transferring the printing material to the printed surface in a predetermined pattern and then pulling the screen away from the printed surface, the mask of the screen adheres to the printed surface and a support force (tension) from the support acts upon the screen. At this time, since the contour shape of the connection portion of the screen with the support of the screen is a curve, the variation of the support force acting upon the screen from the support is reduced and distortion of the screen is suppressed.

If there is a corner or other discontinuous area at the connection portion of the screen, the support force acting from the support is not equal and becomes a cause of distortion of the screen.

In the present invention, however, since the contour shape of the connection portion of the screen with the support is a curve and there is no discontinuous area, the support force acting upon the connection portion of the screen can be easily made uniform.

As a result, when pulling the screen away from the printed surface, a force causing the printing material to be removed as filled in the mask of the screen or deforming the printing material on the printed surface is kept from acting upon the mask of the screen.

### BRIEF DESCRIPTION OF THE DRAWINGS

The above and other objects and features of the present invention will be more apparent from the following description given in relation to the accompanying drawings, wherein:

FIG. 1 is a plan view of an example of the configuration of the printing screen of the related art;

FIG. 2 is a sectional view taken along a line D-D of the printing screen shown in FIG. 1;

FIG. 3 is a sectional view of a printing process using the printing screen shown in FIG. 1;

FIG. 4 is a sectional view of a printing process continuing from FIG. 3;

FIG. 5 is a perspective view of the state where the squeezing is completed in the printing process using the printing screen shown in FIG. 1;

FIG. 6 is a perspective view of the step of pulling the printing screen and the substrate apart from each other in a printing process using the printing screen shown in FIG. 1;

FIG. 7 is a sectional view of deformation of a screen produced when pulling the printing screen and the substrate apart from each other in a printing process using the printing screen shown in FIG. 1;

FIG. 8 is a plan view of an embodiment of the printing screen according to the present invention;

FIG. 9 is a sectional view taken along a line C-C of the printing screen shown in FIG. 8;

FIG. 10 is a perspective view of the state before supplying and squeezing solder paste to the screen of the printing screen;

FIG. 11 is a perspective view of the state after squeezing the solder paste of the printing screen;

FIG. 12 is a perspective view of the state of pulling the printing screen away from the substrate;

FIG. 13 is a plan view of a modification of a printing screen according to the present invention; and

FIG. 14 is a plan view of another modification of the printing screen according to the present invention.

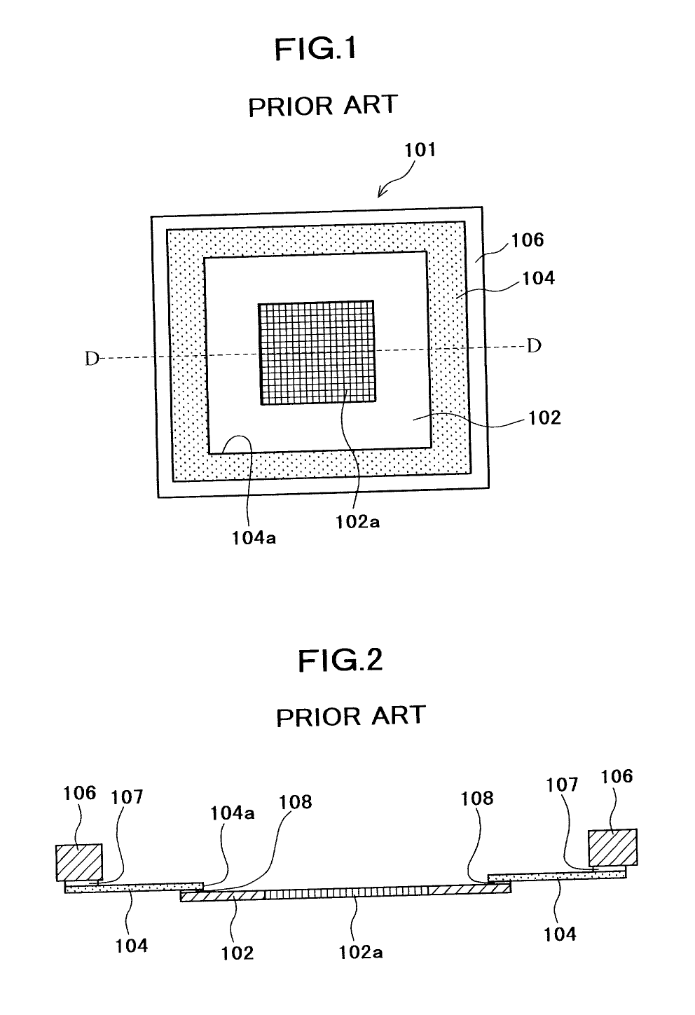

### DESCRIPTION OF THE PREFERRED EMBODIMENTS

Below, an explanation will be made of a preferred embodiment of the present invention with reference to the related figures.

Below, an explanation will be made of an embodiment of the present invention by referring to the drawings.

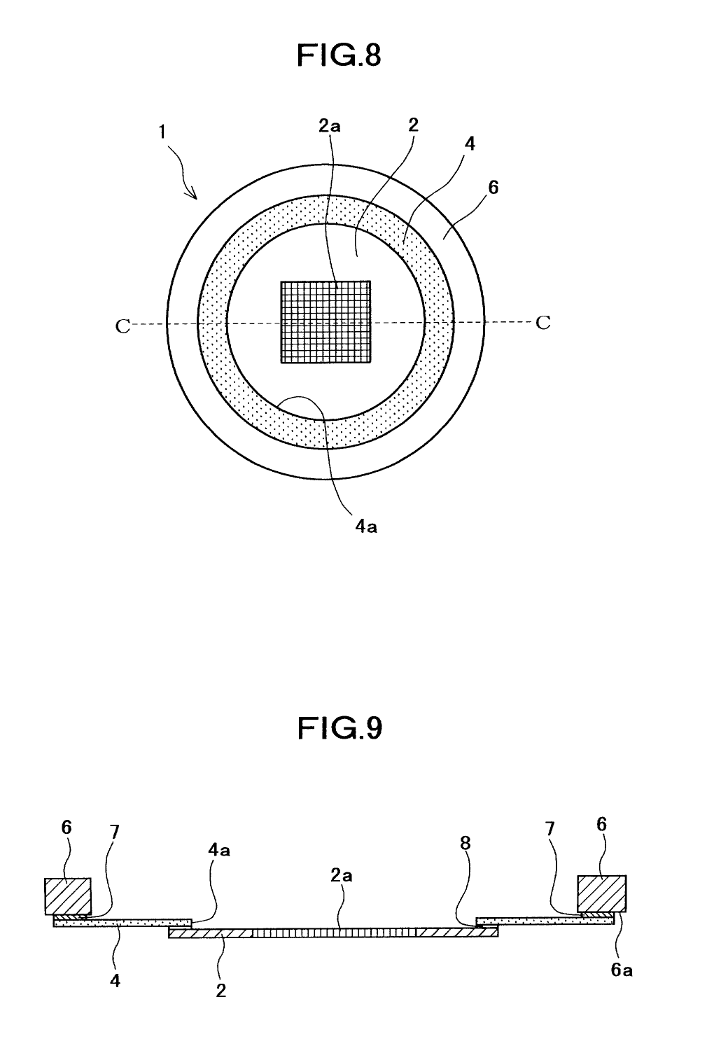

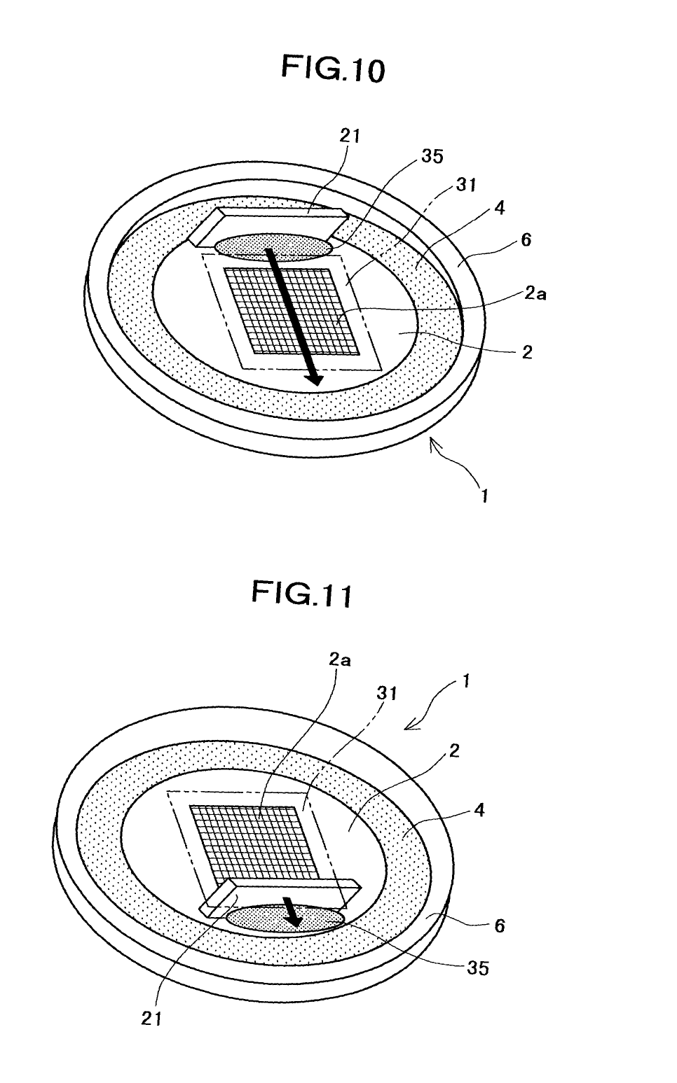

FIG. 8 is a plan view of an embodiment of a printing screen according to the present invention, while FIG. 9 is a sectional view taken along a line C-C of the printing screen shown in FIG. 8.

In FIG. 8 and FIG. 9, a printing screen 1 has a screen 2, a frame 6 arranged away from the outside of the screen 2, and a support member 4 connecting the screen 2 and the frame 6.

The screen 2 is made of a circular sheet member and has a mask 2a formed near its center with a predetermined pattern of openings.

The screen 2 is formed by stainless steel, phosphor bronze, nickel, or another metal material and has a thickness of for example about 40 to 300 μm.

The mask 2a is constituted by a predetermined pattern of a plurality of openings in a direction perpendicular to the surface of the screen 2.

The predetermined pattern of the mask 2a is for example a pattern for forming bumps on electrodes of IC chips formed on an IC wafer or a pattern for forming projecting bumps on electrodes formed on a printed circuit board for mounting electronic components.

The openings of the mask 2a are formed for example using a laser or etching.

The frame 6 is formed from a ring-shaped member. The center of the frame 6 is concentric with the screen 2.

The frame 6 can be made of for example a casting made of aluminum or another metal material or a square pipe member having a rectangular cross-section.

The support member 4 is constituted by a ring-shaped sheet having a circular opening 4a concentric with the screen 2 at its center.

The support member 4 is made of for example one formed from a mesh of a fiber. The fiber forming the support member 4 is made of polyester, nylon, or other synthetic resin fiber or stainless steel or another metal fiber.

Since the support member 4 is comprised of a mesh of a fiber, it has elasticity with respect to a force acting in the plane of the support member 4.

As shown in FIG. 9, the inner periphery of one surface of the support member 4 is connected to the outer periphery of the surface of the screen 2 via an adhesive 8, while the outer periphery of the other surface of the support member 4 is connected to one end face 6a of the frame 6 via an adhesive 7.

The contour shapes of the connection portions of the support member 4 with the frame 6 and with the screen 2 become concentric circles.

The support member 4 is bonded to the frame 6 and the screen 2 so as to impart uniform tension to the radial direction of the screen 2.

Next, an explanation will be given of an example of the method of printing on a substrate using the printing screen 1 having the above configuration.

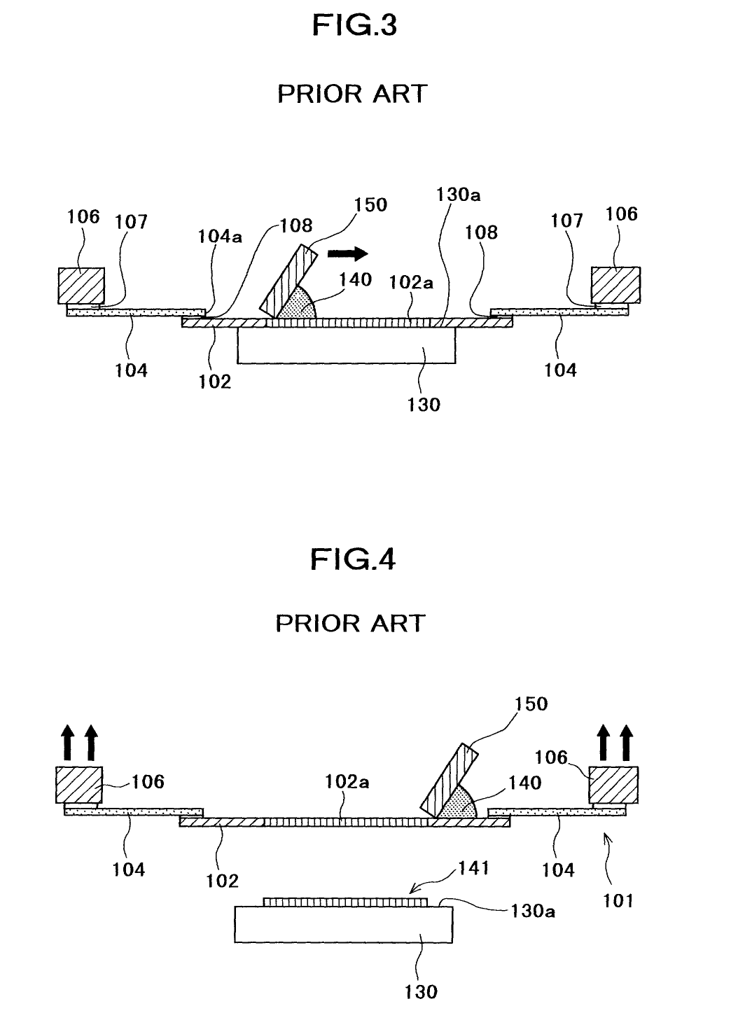

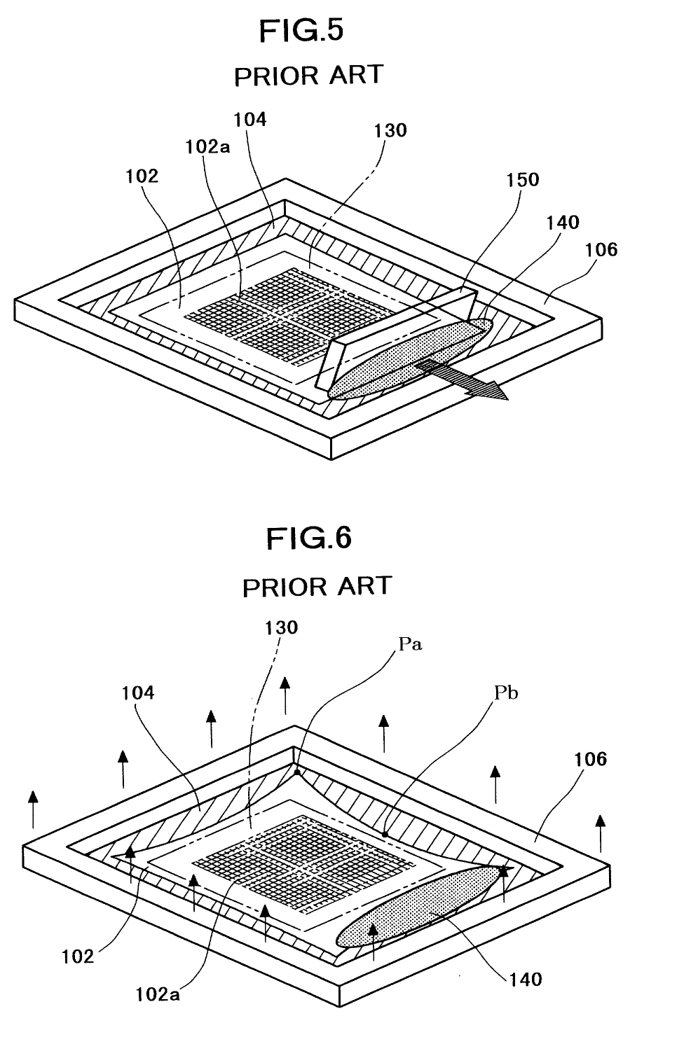

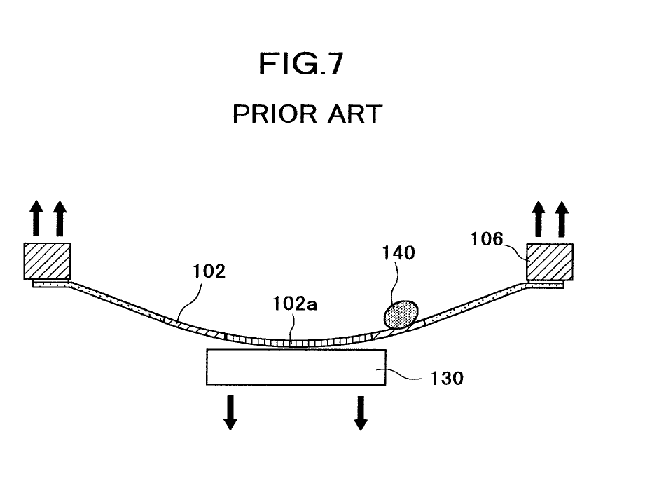

First, as shown in FIG. 3, the printing screen 1 is positioned with respect to the substrate 31, and the screen 2 and the printed surface of a substrate 31 are brought into face contact.

Note that the substrate 31 is for example a printed circuit board formed on the printed surface with a large number of electrodes for mounting electronic components or a semiconductor wafer such as a silicon substrate formed with a large number of IC chips.

Next, an area other than the mask 2a on the screen 2 is supplied with a printing material, for example, a solder paste 35, then the front end of a squeegee 21 made of a plate-like rubber member having elasticity is made to move in the arrow direction while in contact with the surface to which the solder paste 3 is supplied

By moving the squeegee 21 while pressing it obliquely down toward the substrate 31, the solder paste 35 is rolled at the front surface of the forward direction of the squeegee 21. The solder paste 35 is therefore filled in the openings of the mask 2a.

The solder paste 35 filled in the openings of the mask 2a deposits on the corresponding electrodes of the substrate 31 contacting the screen 2.

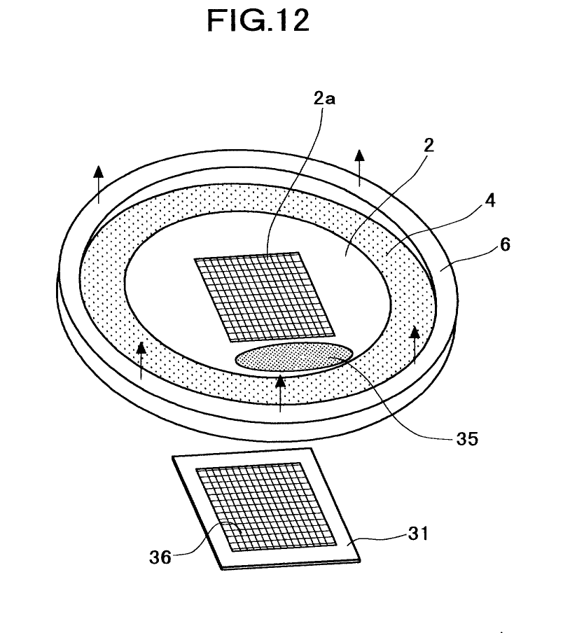

Next, as shown in FIG. 11, after the solder paste 35 is made to passed over the entire mask 2a, the squeeze 21 is pulled away from the screen 2 and, as shown in FIG. 12, the printing screen 1 is pulled away from the substrate 31.

If the screen 2 is pulled away in a direction perpendicular to the printed surface of the substrate 31, as shown in FIG. 12, a predetermined solder paste pattern 36 is formed on the printed surface of the substrate 31.

When pulling the screen 2 away from the printed surface of the substrate 31, since the surface of the screen 2 facing the printed surface of the substrate 31 adheres to the printed surface, a force acts upon the screen 2 trying to move it relative to the frame 6 along with movement of the frame 6 and tension is imparted from the support member 4 to the screen 2 through the connection portion with the support member 4.

The contour shapes of the connection portion between the screen 2 and the support member 4 and the connection portion between the frame 6 and the support member 4 are concentrically circular, so the tension acting upon the connection portion between the frame 6 and the support member 4 is substantially equal in the circumferential direction and the tension acting upon the connection portion between the screen 2 and the support member 4 becomes substantially equal in the circumferential direction.

For this reason, no locally large tension acts upon the screen 2, and the screen 2 will not locally deform.

Since no large distortion occurs in the screen 2, the solder paste 35 filled in the openings of the mask 2a of the screen 2 is transferred onto the substrate 31 without being removed from the top of the substrate 31 by the screen 2 and without a large loss of shape.

As a result, a predetermined pattern of the solder paste 35 is formed on the substrate with a high precision.

As described above, according to the present embodiment, by making the contour shapes of the connection portions of the support member 4 with the screen 2 and the frame 6 circular without corners, when pulling the printing screen 1 away from the substrate 31, the tension acting upon the screen 2 from the support member 4 can be made substantially equal in the circumferential direction and distortion of the screen 2 can be suppressed as much as possible.

As a result, bumps made of solder paste 35 can be formed with a high precision on the electrode pads of a printed circuit board formed on the printed surface with a large number of electrodes for mounting electronic components or a silicon substrate or other semiconductor wafer formed with a large number of IC chips.

Note that, the present invention is not limited to the above embodiment.

In the above embodiment, both of the contour shapes of the connection portions of the screen 2 with the frame 6 and the support member 4 were made circular, but even if making only the connection portion between the screen 2 and the support member circular, an effect of relieving the unbalance of tension acting upon the screen 2 can be obtained. Further, the contour shapes of the connection portions of the screen 2 with the frame 6 and the support member 4 may also be made ellipses or other curves. Even if this structure is employed, the unbalance of the tension acting upon the screen 2 can be relieved.

Further, in the embodiment, a sheet-like material having elasticity formed as a mesh on the support member 4 was used, but the present invention is not limited to this. For example, it is also possible to radially connect the screen 2 and the frame 6 by a large number of metal wires and impart the tension to the screen 2.

Further, the printing work is carried out by mounting the printing screen 1 on a printing machine. In existing printing machines, generally the shape of the mounting portion on which the printing screen 1 is mounted is rectangular. Accordingly, in the case of the shape of the frame 6 described above, the printing screen 1 cannot be mounted on the printing machine.

For this reason, for example, the outer shape of the frame 6 can be matched to the shape of the mounting portion of the printing machine while maintaining the circular contour shape of the connection portion between the frame 6 and the support member 4.

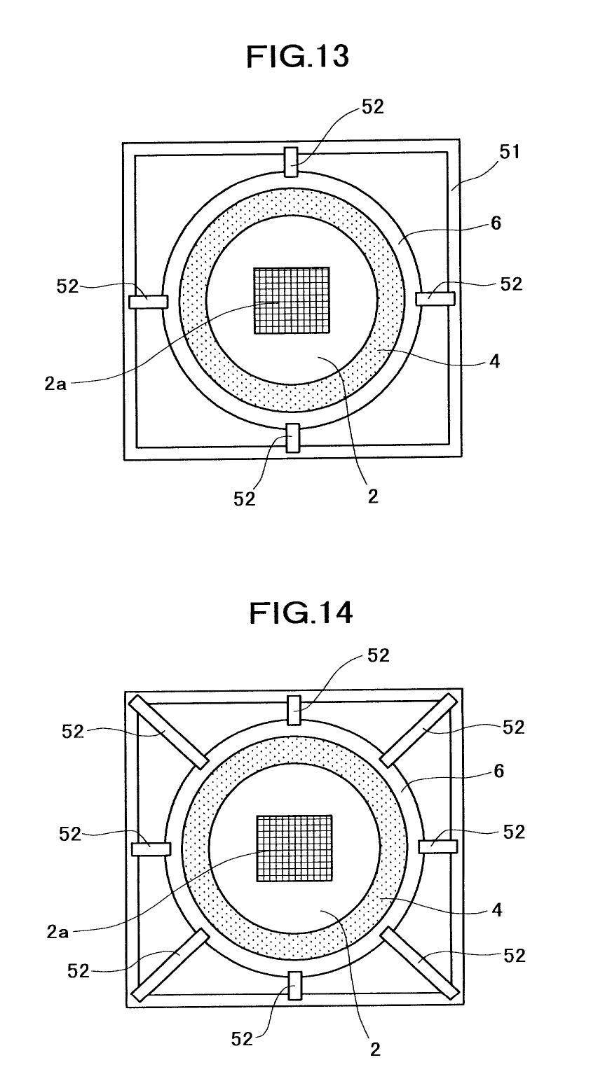

For example, as shown in FIG. 13, a structure in which a rectangular mounting frame 51 which can be mounted on the mounting portion of the printing machine is provided on the outside of the frame 6 and in which the mounting frame 51 and the frame 6 are connected by a support member 52 can be employed.

By using a highly rigid material for the mounting frame 51, when the screen 2 and the substrate 31 are pulled apart, the deformation of the frame 6 due to the force acting upon the screen 2 can be suppressed.

Further, for example, as shown in FIG. 14, by providing a further larger number of support members 52 on the outer circumference of the frame 6, the deformation of the frame 6 can be reliably prevented.

According to the present invention, printing defects due to the distortion of the screen occurring when supplying a printing material onto a screen, transferring a predetermined pattern of the printing material to the printed surface of the printing object through a mask formed on the screen, then pulling the printed surface and the screen apart from each other, can be suppressed and it becomes possible to print the predetermined pattern of the printing material with a high precision.

Further, according to the present invention, bumps can for example be correctly formed on fine electrode pads of a semiconductor wafer or printed circuit board.

What is claimed is:

1. A printing screen comprising:
a screen provided with a mask formed with a predetermined pattern of openings into which a printing material is to be filled,
a frame arranged away from the outside of said screen, and
a support which connects said frame and said screen and supports said screen moveably with respect to said frame, wherein
a contour of a connection portion of said screen to which said support is connected is formed as a curve.

2. A printing screen as set forth in claim 1, wherein a contour of a connection portion of said frame to which said support is connected is formed as a curve.

3. A printing screen as set forth in claim 1, wherein said contour of said connection portion of said screen comprises a circle.

4. A printing screen as set forth in claim 2, wherein said contour of said connection portion of said frame comprises a circle.

5. A printing screen as set forth in claim 1, wherein contours of said connection portion of said screen and said connection portion of said frame are concentric circles.

6. A printing screen as set forth in claim 1, wherein said support supports said screen in a state imparting tension to said screen.

7. A printing screen as set forth in claim 1, wherein said screen is made of a metal material.

8. A printing screen as set forth in claim 1, wherein said support is a sheet of a mesh of fibers.

9. A printing screen as set forth in claim 1, wherein:
said frame is a ring member having at least one end face and
said support is bonded to said end face.

10. A printing screen as set forth in claim 8, wherein said support and said screen are bonded to each other's surfaces.

11. A printing screen as set forth in claim 8, wherein said fiber is made of a metal material.

12. A printing screen as set forth in claim 8, wherein said fiber is made of a synthetic resin.

13. A printing screen as set forth in claim 1, wherein said predetermined pattern of a mask is a pattern for forming a bump on an electrode of an IC chip formed on a semiconductor wafer.

14. A printing screen as set forth in claim 1, wherein said predetermined pattern of a mask is a pattern for forming a bump on an electrode formed on printed circuit board for mounting an electronic device.

15. A printing screen as set forth in claim 1, wherein one surface of the screen is supplied with the printing material to be transferred to the object being printed and is brought into contact with a moving squeegee.

16. A printing screen as set forth in claim 1, wherein said frame has a shape enabling mounting to a predetermined mounting portion of a printing machine.

17. A printing screen as set forth in claim 1, further having an mounting frame mountable to a predetermined mounting portion of a printing machine.

18. A printing screen as set forth in claim 17, wherein:
said frame is a ring-shaped member,
said mounting frame is arranged away from the outside of the frame, and
said frame and said mounting frame are connected by a support member.

19. A printing screen as set forth in claim 18, wherein said support member is arranged at substantially equal intervals along the outer periphery of the frame.

20. A printing screen as set forth in claim 19, wherein said mounting frame is a rectangular member.

21. A printing screen as set forth in claim 1, wherein said printing material is a solder paste.

22. A printing screen as set forth in claim 8, wherein said support has elasticity with respect to force acting in the plane of the support.
